(19) United States
(12) Patent Application Publication
(10) Pub. No.: US 2015/0326612 A1
(43) Pub. Date: Nov. 12, 2015

(54) TECHNIQUES FOR NETWORK SELECTION IN UNLICENSED FREQUENCY BANDS

(71) Applicant: QUALCOMM Incorporated, San Diego, CA (US)

(72) Inventors: Stefano FACCIN, Hayward, CA (US); Miguel GRIOT, La Jolla, CA (US); Gavin Bernard HORN, La Jolla, CA (US)

(21) Appl. No.: 14/704,539

(22) Filed: May 5, 2015

Related U.S. Application Data
(60) Provisional application No. 61/989,308, filed on May 6, 2014.

(51) Int. Cl. H04L 29/06; H04W 12/08

(52) U.S. Cl. CPC H04L 63/20; H04L 63/10; H04W 12/08; H04L 63/101

(57) ABSTRACT

Aspects described herein relate to detecting wireless network services. A network that advertises access to a service provider network via a cellular radio access technology (RAT) in an unlicensed frequency can be discovered at a user equipment (UE). The UE can then determine one or more user-defined or operator-defined policies related to selecting the network, and select the network for access based at least in part on the one or more user-defined or operator-defined policies.

### CLAIM OF PRIORITY UNDER 35 U.S.C. §119

The present application for patent claims priority to Provisional Application No. 61/989,308 entitled “APPARATUS AND METHOD FOR LTE OVER UNLICENSED NETWORK SELECTION” filed May 6, 2014, which is assigned to the assignee hereof and hereby expressly incorporated by reference herein.

### BACKGROUND

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple user equipment devices (UE). Each UE communicates with one or more base stations, such as an evolved Node B (eNB) via transmissions on the forward and reverse links. The forward link (or downlink) refers to the communication link from the eNBs to the UEs, and the reverse link (or uplink) refers to the communication link from the UEs to the eNBs. This communication link may be established via a single-in-single-out, multiple-in-single-out or a multiple-in-multiple-out (MIMO) system. In this regard, the UEs can access wireless network via one or more eNBs.

Network deployment for these systems is typically fixed, and thus the eNBs communicate with a home network related to a UE to obtain and/or verify subscription information for the UE on a given network. Wireless networks typically employ a home subscriber server (HSS) for managing information relating to UEs subscriber to the wireless network, which may be based on identifying the UE using its international mobile subscriber identifier (IMSI) and/or other identification. In this regard, eNBs providing wireless network access to a UE can communicate with the UE's HSS (e.g., by traversing one or more network nodes) to verify the UE's subscription. In many examples, the eNB can be on a visiting network and can access the HSS on the UE's home network to verify the subscription.

There is a desire, however, to allow UEs to communicate using one or more wireless network technologies in other contexts over third-party networks where authentication is managed by an owner of the third-party network and/or where frequency bands in unlicensed spectrums are used for communications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an example, a method for detecting wireless network services is provided. The method includes discovering, at a user equipment (UE), a network that advertises access to a service provider network via a cellular radio access technology (RAT) in an unlicensed frequency. The method also includes determining, by the UE, one or more user-defined or operator-defined policies related to selecting the network, and selecting the network for access based at least in part on the one or more user-defined or operator-defined policies.

In another example, an apparatus for detecting wireless network services is provided. The apparatus includes a network discovering component configured to discover a network that advertises access to a service provider network via a cellular radio access technology (RAT) in an unlicensed frequency, a user-defined policy component or an operator-defined policy component configured to determine one or more user-defined or operator-defined policies related to selecting the network, and a network connecting component configured to select the network for access based at least in part on the one or more user-defined or operator-defined policies.

In yet another example, an apparatus for detecting wireless network services is provided. The apparatus includes means for discovering a network that advertises access to a service provider network via a cellular radio access technology (RAT) in an unlicensed frequency, means for determining one or more user-defined or operator-defined policies related to selecting the network, and means for selecting the network for access based at least in part on the one or more user-defined or operator-defined policies.

In another example, a computer-readable storage medium comprising computer-executable code for detecting wireless network services is provided. The code includes code for discovering a network that advertises access to a service provider network via a cellular radio access technology (RAT) in an unlicensed frequency, code for determining one or more user-defined or operator-defined policies related to selecting the network, and code for selecting the network for access based at least in part on the one or more user-defined or operator-defined policies.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 illustrates an example system for providing hotspot access in accordance with aspects described herein.

FIG. 2 illustrates an example system for offloading wireless communication services in accordance with aspects described herein.

FIG. 3 illustrates an example system for selecting various types of networks in accordance with aspects described herein.

FIG. 4 illustrates an example method for selecting various types of networks in accordance with aspects described herein.

FIG. 5 illustrates an example method for selecting various types of networks in accordance with aspects described herein.

FIG. 6 illustrates a multiple access wireless communication system according to aspects described herein.

FIG. 7 illustrates a block diagram of a communication system.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

Described herein are various aspects related to providing network selection between mobile network operator (MNO) networks, networks operating using cellular radio access technologies (RAT) in unlicensed frequency spectrums, and/or wireless local area networks (WLAN). In one specific deployment, a network can allow communications from user equipment (UE) using a RAT of a related MNO to access the MNO, and can utilize components of an existing local area network (LAN) to provide backend access to a MNO network. Selection between these various types of networks can occur by an automatic or manual selection based on one or more user preferences, operator policies, type of the target network, type of a currently used network, etc. In addition, blacklisting can be defined for accessing such networks where the networks may use ambiguous identifiers.

In a specific example, the MNO network can utilize a long term evolution (LTE) or similar RAT to facilitate communicating with a UE to provide network access. As described herein, LTE may also refer to LTE Advanced (LTE-A). Moreover, LTE may represent an example of a wireless wide area network (WWAN) or cellular network such that aspects described herein for LTE may also be applicable to substantially any WWAN/cellular network. In this regard, LTE over unlicensed spectrum (LTE-U) can also be deployed to extend wireless network coverage. LTE over unlicensed spectrum may refer to a network operating using LTE in an unlicensed frequency band, which may include a contention-based radio frequency band or spectrum.

In an example deployment, an LTE-U eNB communicates in a radio access network (RAN) using LTE and provides network access in an existing service provider wireless LAN (WLAN) (e.g., for accessing an MNO or otherwise). This is referred to as LTE-U-WLAN (LTE-U-W). In another deployment, an LTE-U eNB communicates in an environment controlled by the MNO that includes backend components of a mobile network to provide network access (e.g., for communicate with the MNO or otherwise). This is referred to as LTE-U-MNO (LTE-U-M). In yet another example, the LTE-U eNB allows for offloading UE traffic from the MNO network to an LTE-U-M, which is referred to as an LTE-U-offload (LTE-U-O) network. Various aspects of selecting between LTE, LTE-U-M, LTE-U-W, LTE-U-O, and/or WLAN networks for network access are described herein.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, user equipment, or user equipment device. A wireless terminal can be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station can be utilized for communicating with wireless terminal(s) and can also be referred to as an access point, access node, a Node B, evolved Node B (eNB), or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (WiFi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN (WLAN), BLUETOOTH and any other short- or long-range, wireless communication techniques.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

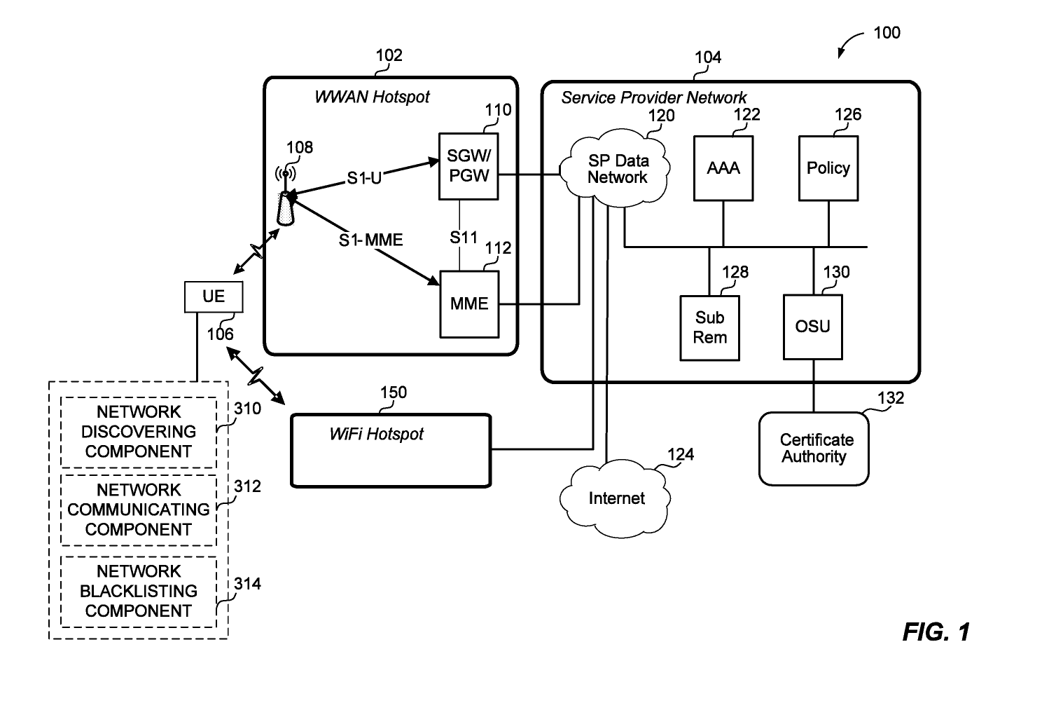

Referring to FIG. 1, a wireless communication system 100 is illustrated that facilitates providing wireless access to network services. System 100 includes a WWAN hotspot 102, which can provide a cell to receive wireless communications from one or more UEs to provide access to a backend service provider network 104 (e.g., via one or more other co-located or remotely located network nodes). In this example, the components shown in the WWAN hotspot 102 typically may communicate to provide access to a specific MNO using the wireless communication service, such as LTE, GSM, etc. In this example, the WWAN hotspot 102 can provide the cell using a cellular RAT in an unlicensed frequency band, such as LTE, GSM, etc., to provide access to the backend service provider network 104. Thus, for example, a UE 106 communicates with an eNB 108 to access a serving gateway (SGW)/packet data network (PDN) gateway (PGW) 110 and/or a mobility management entity (MME) 112, which may be included in the hotspot 102, using the cellular RAT. UE 106 can include one or more UEs described herein, and thus may include a network discovering component 310 for discovering one or more networks for which access is advertised (e.g., by a WWAN hotspot 102, WiFi hotspot 150, etc.), a network connecting component 312 for communicating with one or more of the networks based at least in part on one or more policies, and/or a network blacklisting component 314 for adding a network for which authentication fails to a blacklist to prevent subsequent attempts for accessing the network for at least a period of time.

UE 106 can include any type of mobile device, such as, but not limited to, a smartphone, cellular telephone, mobile phone, laptop computer, tablet computer, or other portable networked device that can be a standalone device, tethered to another device (e.g., a modem connected to a computer), and/or the like. In addition, UE 106 may also be referred to by those skilled in the art as a mobile station, a subscriber station, a mobile unit, a subscriber unit, a wireless unit, a remote unit, a mobile device, a mobile communications device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In general, UE 106 may be small and light enough to be considered portable and may be configured to communicate wirelessly via an over-the-air communication link using one or more OTA communication protocols described herein. Additionally, in some examples, UE 106 may be configured to facilitate communication on multiple separate networks via multiple separate subscriptions, multiple radio links, and/or the like.

eNB 108 may include an access point, such as a macro cell access point, a small cell access point, and/or the like. As used herein, the term “small cell” may refer to an access point or to a corresponding coverage area of the access point, where the access point in this case has a relatively low transmit power or relatively small coverage as compared to, for example, the transmit power or coverage area of a macro network access point or macro cell. For instance, a macro cell may cover a relatively large geographic area, such as, but not limited to, several kilometers in radius. In contrast, a small cell may cover a relatively small geographic area, such as, but not limited to, a home, a building, or a floor of a building. As such, a small cell may include, but is not limited to, an apparatus such as a BS, an access point, a femto node, a femtocell, a pico node, a micro node, a Node B, eNB, home Node B (HNB) or home evolved Node B (HeNB). Therefore, the term “small cell,” as used herein, refers to a relatively low transmit power and/or a relatively small coverage area cell as compared to a macro cell.

In typical LTE deployments, for example, the MME 112 provides the UE 106 with bearer setup procedures, access to SGW/PGW 110 and other core MNO network components (e.g., an HSS), etc., and SGW/PGW 110 provides the UE 106 with access to an Internet connection and/or other external nodes. In the depicted example, however, SGW/PGW 110 and MME 112 provide the UE 106 with access to service provider (SP) data network 120. The SP data network 120 can relate to providing network access for a WiFi Hotspot 150, and can also be utilized, in this example, by the WWAN Hotspot 102 to additionally provide access to Internet 124 for UE 106 (e.g., to access a home network of the UE 106 for authentication, billing, or other purposes, and/or to access other network nodes to provide wireless network services). This configuration can be referred to as an LTE-U-W deployment.

It is to be appreciated, in this regard, that the MME 112 can setup a bearer for UE 106 to communicate via eNB 108 to access components of the service provider network 104 via SP data network 120. This can include setting up a radio bearer between UE 106 and eNB 108 as well as a data bearer between eNB 108 and SGW/PGW 110 and/or additional components of network 104. In addition, the user and control plane communications may be collapsed for communicating with certain elements in the network 104. Moreover, for example, security can be modified such to use extensible authentication protocol (EAP) or similar security mechanisms over the non-access stratum (NAS) layer between UE 106 and MME 112, as described further herein.

Network 104 further includes an AAA server 122 for establishing and verifying credentials of UE 106 for accessing the network 104. SP data network 120 can also provide access to Internet 124. Additional servers may optionally be included in the network 104 as well, such as a policy server 126 that can define one or more access policies for a set of credentials, a subscription remediation server 128 that can resolve subscription errors and/or timeouts, and/or an online sign-up (OSU) server 130 for managing subscription credentials for accessing network 104. OSU server 130 can communicate with certificate authority 132 to obtain one or more certificates for managing subscription-based access to network 104. In an example, network 104 can also include a router (not shown) to facilitate WiFi or other wireless access thereto.

In an example, eNB 108 can advertise LTE-U-W network services, which are discoverable by UE 106, by broadcasting one or more messages indicating available services. The UE 106 can detect the broadcast message from the eNB 108, and can determine whether to establish a connection with the eNB 108 (e.g., based on information in the broadcast message) using one or more policies, as described further herein. This can be similar to a mechanism used by components of WiFi Hotspot 150 to advertise existence of the Hotspot (e.g., by advertising a network identifier such as a service set identification (SSID), etc.). Thus, in the LTE-U-W deployment, the service provider can use the same core network elements for provisioning, accounting, policy, authentication, etc. for the WWAN Hotspot 102 as is used for the WiFi Hotspot 150, and thus, the UE 106 can, in some examples, use the same credentials to access the WWAN Hotspot 102 or the WiFi Hotspot 150, as the credentials can relate to the service provider and/or related network 104. In addition, in some examples, the UE 106 universal subscriber identity module (USIM) can be used to provide credentials for accessing the WWAN Hotspot 102 (e.g., where the Hotspot 102 can access MNO components via Internet 124, and/or where WWAN Hotspot 102 otherwise provides LTE-U-M access). Moreover, it is to be appreciated that online sign-up can be possible for both the WWAN Hotspot 102 and WiFi Hotspot 150 via OSU server 130.

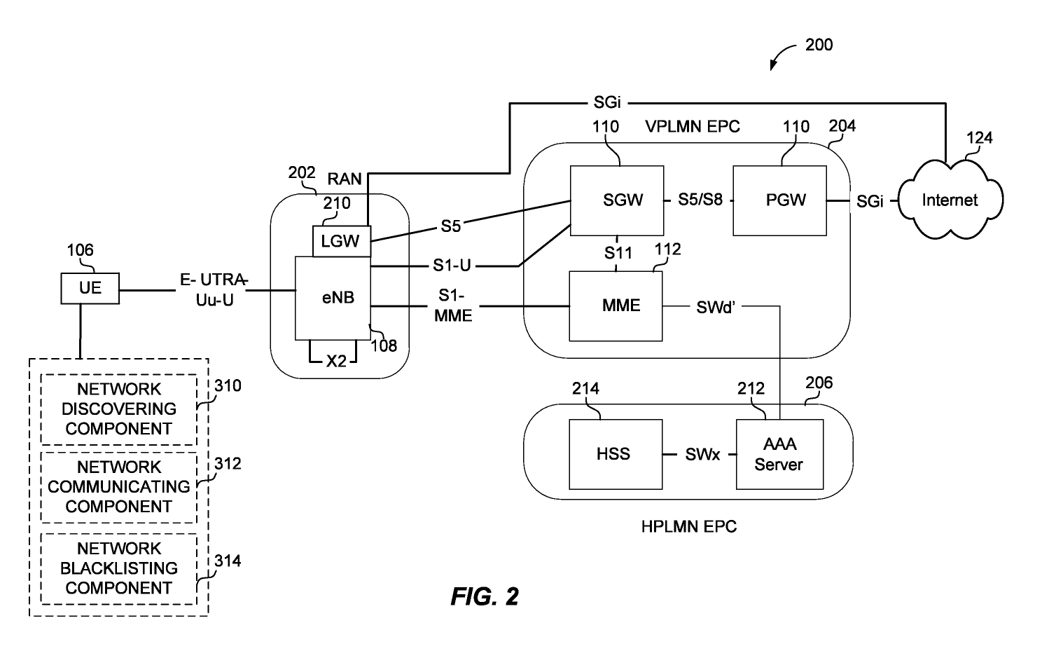

Referring to FIG. 2, a wireless communication system 200 is illustrated that facilitates providing wireless access to network services. System 200 includes a radio access network (RAN) 202 that provides LTE-U for an MNO (LTE-U-M), which may be used to offload traffic from an LTE network (LTE-U-O), where the RAN 202 communicates with a visiting public land mobile network (PLMN) evolved packet core (EPC) 204 to allow access to a home PLMN (HPLMN) EPC 206 that manages credentials for certain UEs. VPLMN EPC 204 also provides access to Internet 124 for authenticated UEs. RAN 202 comprises an eNB 108 and a local gateway (LGW) 210 that facilitate communicating with components of the visiting PLMN (VPLMN) EPC 204 and/or Internet 124. VPLMN EPC 204 is referred to as the visiting PLMN because it is not the HPLMN for UE 106, in this example. VPLMN EPC 204 comprises a SGW/PGW 110 (depicted as separate devices) and an MME 112. HPLMN EPC 206 includes an AAA server 212, which may be different than AAA server 122 of network 104 (FIG. 1) as this AAA server 212 manages AAA functions of the HPLMN EPC for the UE 106, and an HSS 214 for storing subscription information of certain UEs.

In this example, the VPLMN EPC 204 and HPLMN EPC 206 can function as a typical mobile network to provide UEs related to the HSS 214 of the HPLMN EPC 206 with access to Internet 124 or other network resources based on the VPLMN EPC 204 verifying subscription information of the UE 106 with HPLMN EPC 206. The RAN 202 can be deployed at a third party that connects to the VPLMN EPC 204 via Internet 124 (e.g., using LGW 210). In this example, eNB 108 operates in an unlicensed frequency spectrum, as with eNB 108 in FIG. 1, to communicate with UE 106, and provides UE 106 with access to Internet 124 by traversing the VPLMN EPC 204 to which RAN 202 connects, and/or HPLMN EPC 206 related to the UE 106. Thus, for example, UE 106 can use universal subscriber identity module (USIM) credentials to access RAN 202, where RAN 202 verifies the credentials by accessing HPLMN EPC 206. In this regard, the UE 106 can utilize Internet 124 by offloading to RAN 202 where RAN 202 is able to authenticate the UE 106 via HPLMN EPC 206.

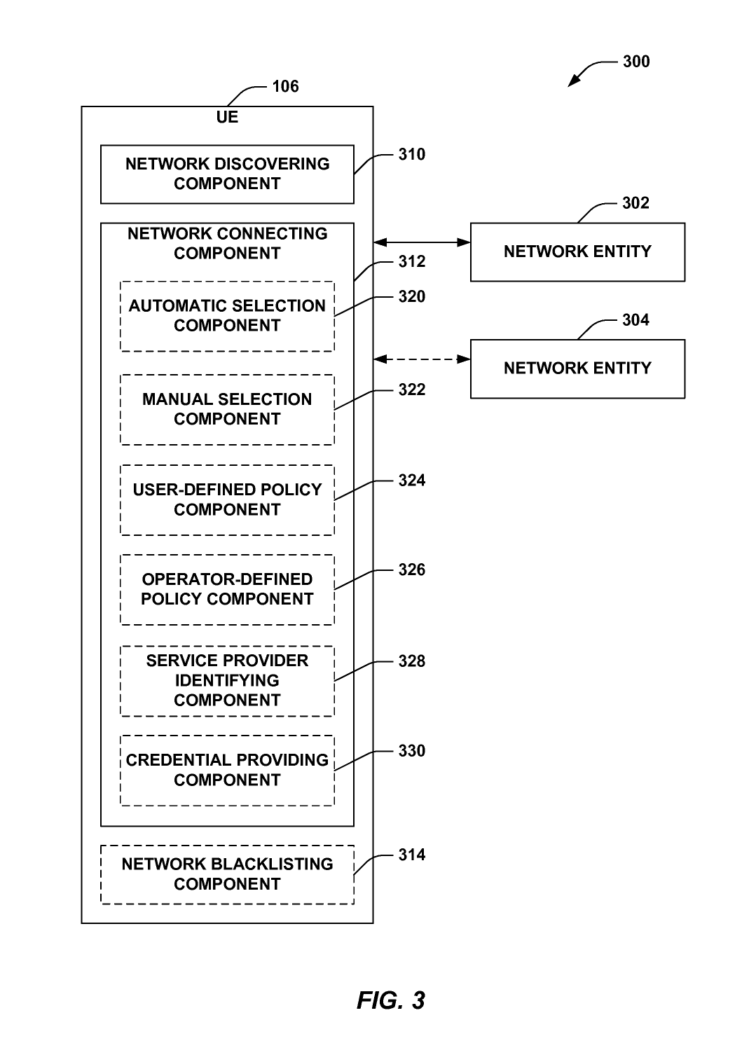

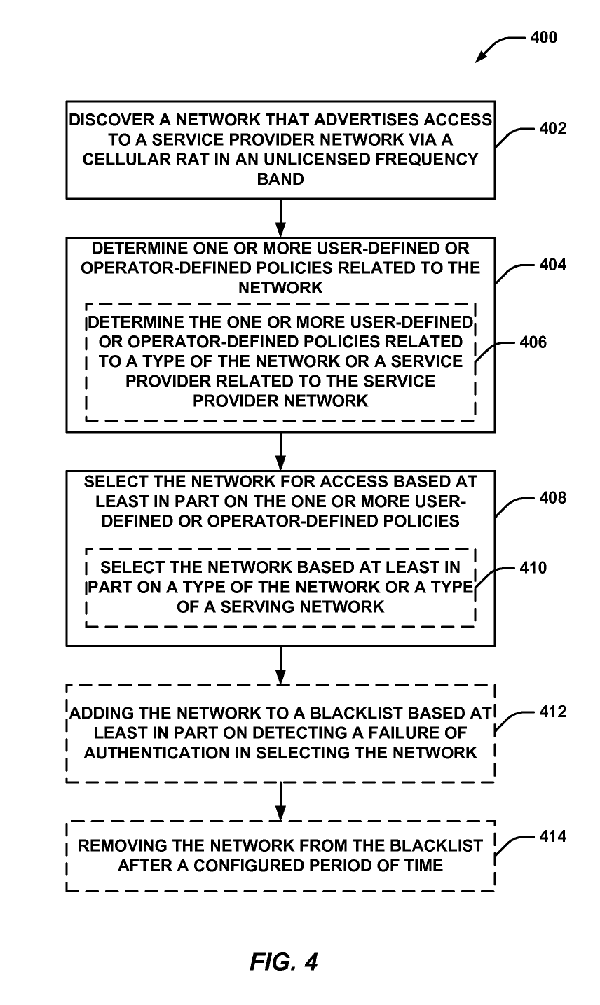

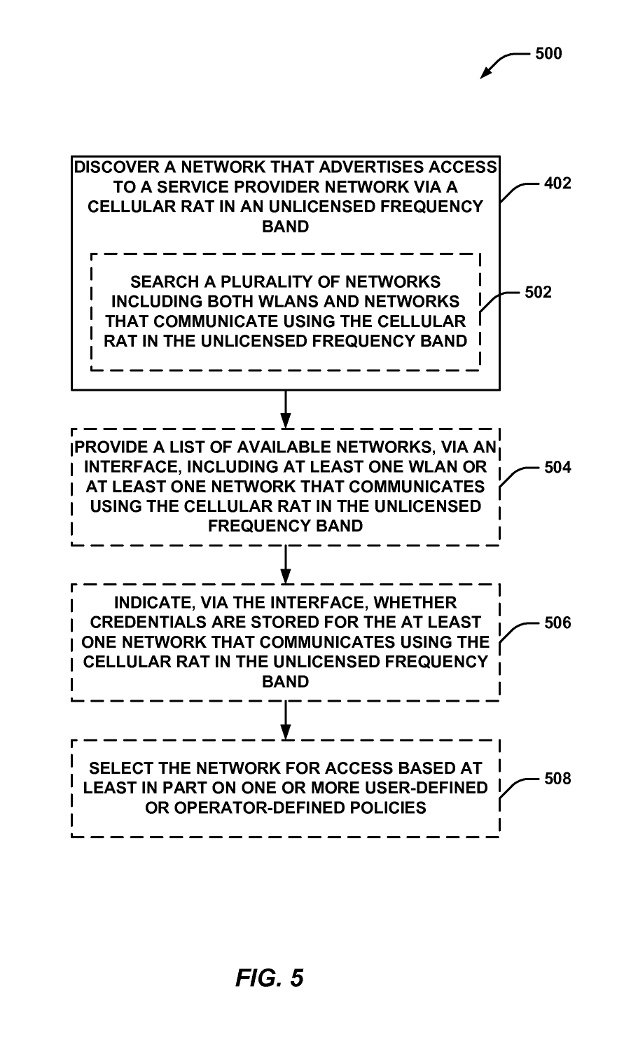

Turning now to FIGS. 3-5, aspects are depicted with reference to one or more components and one or more methods that may perform the actions or functions described herein. Although the operations described below in FIG. 4-5 are presented in a particular order and/or as being performed by an example component, it should be understood that the ordering of the actions and the components performing the actions may be varied, depending on the implementation. Moreover, it should be understood that the following actions, functions, and/or described components may be performed by a specially-programmed processor, a processor executing specially-programmed software or computer-readable media, or by any other combination of a hardware component and/or a software component capable of performing the described actions or functions.

FIG. 3 depicts a system 300 for selecting from multiple types of wireless networks for accessing based at least in part on one or more user-defined or operator-defined policies. System 300 includes a UE 106 that communicates with a network entity 302 and/or network entity 304 to access a wireless network. Network entities 302/304, for example, may include an eNB, such as eNB 108, or other component of a WWAN Hotspot 102 or WiFi Hotspot 150 that can communicate information to UE 106 regarding one or more available networks.

UE 106 may include a network discovering component 310 for discovering one or more networks for possible selection where the one or more networks may include LTE networks, LTE-U-W networks, LTE-U-M networks, LTE-U-O networks, etc., a network connecting component 312 for possibly connecting to at least one of the one or more networks based at least in part on one or more user-defined or operator-defined policies, a type of the one or more networks, a type of a current serving network, etc., and/or an optional network blacklisting component 314 for adding one or more networks to a blacklist of networks where authentication to the one or more networks fails.

Network connecting component 312 may optionally include an automatic selection component 320 for selecting a network for access based at least in part on one or more user-defined or operator-defined policies, a manual selection component 322 for allowing manual selection of a network for access, a user-defined policy component 324 for defining and managing one or more user-defined policies related to accessing one or more networks (e.g., or types of networks, certain service providers, etc.), an operator-defined policy component 326 for defining and managing one or more operator-defined policies (e.g., defined by an MNO related to UE 106) for accessing one or more networks, a service provider identifying component 328 for identifying a service provider related to one or more discovered networks, and/or a credential providing component 330 for storing and providing credentials for accessing one or more discovered networks.

FIG. 4 depicts an example method 400 for selecting a network to access based on information received regarding the network. Method 400 of FIG. 4 includes, at Block 402, discovering a network that advertises access to a service provider network via a cellular RAT in an unlicensed frequency band. Network discovering component 310 can discover the network that advertises access to the service provider network via the cellular RAT in the unlicensed frequency band. In one example, UE 106 can communicate with network entity 302 to receive wireless network access, and network discovering component 310 can discover network entity 304. For instance, network entity 304 can broadcast signals to facilitate discovery in this regard (e.g., using the cellular RAT over the unlicensed frequency band). Accordingly, network discovering component 310 can be configured to receive signals in the unlicensed frequency band during one or more periods (e.g., measurement periods configured by or otherwise negotiated with network entity 302, etc.). Network connecting component 312 can determine whether to additionally or alternatively connect to network entity 304 to receive network access, as described further herein. As described, the network entities 302 and 304 can relate to networks that use similar RATs, but may communicate in different frequency spectrums, networks that use different RATs, networks that leverage the same service provider network, and/or the like. In one example, the network or related network entity 302/304 can utilize LTE RAT in an unlicensed frequency spectrum to advertise and provide network access services, LTE in a licensed frequency spectrum, WiFi, etc. As described further herein, network discovering component 310 can discover the network and/or other networks that utilize various RATs in various spectrums.

Method 400 includes, at Block 404, determining one or more user-defined or operator-defined policies related to the network. Network connecting component 312 can determine the one or more user-defined policies (e.g., via user-defined policy component 324) or operator-defined policies (e.g., via operator-defined policy component 326) related to the network. For example, user-defined policy component 324 can facilitate defining and/or otherwise storing of one or more policies defined by a user of the UE 106. For example, UE 106 may include an interface to allow a user to define the policy via input/output devices of the UE 106 (e.g., a touchscreen, keyboard, mouse, display, etc.), an interface to allow a user to specify one or more remote or local storage locations for a policy, an interface to allow a user to download a policy to the UE 106, etc. For example, the user-defined policies may specify one or more networks, network types, networks operated by certain providers, etc. to select upon discovery, where the selection may be based on a set of rules (e.g., rules to prefer certain networks or network types over others, rules related to providing credentials to the networks, etc.). Additionally, the policies may specify certain parameters for selecting certain networks, types of networks, networks related to certain operators/service providers, etc., such as whether simultaneous connection to a certain network, type of network, network related to a certain operator/service provider is allowed (e.g., for offloading) when connected to another network, type of network, network related to a certain operator/service provider, whether handover and/or reselection is allowed between the networks, types of networks, networks of the operators/service providers, etc. In another example, the policies may specify times of day to allow connection to a certain network, type of network, network related to a certain operator/service provider, etc. Moreover, in an example, the user-defined policies may include parameters for connecting to networks for which the UE 106 has stored credentials, as described further herein.

Similarly, operator-defined policy component 326 can allow for receiving operator-defined policies, which may be provisioned from a network (e.g., from network entity 302, via network entity 302 from one or more core network components that may include subscription related information of the UE 106, etc.). In another example, operator-defined policy component 326 can allow for receiving policies stored on the UE 106 (e.g., on a USIM or other storage of the UE 106), etc. For example, the operator-defined policies may define one or more parameters related to connecting to certain networks, network types, networks operated by certain operators/service providers, etc., as described above. For example, the operator-defined policies may define parameters related to connecting to the network, type of network, network related to the certain operator/service provider, etc. as a simultaneous connection or in handing over to another network, type of network, network related to the same or different operator/service provider, etc.

In one example, determining the one or more user-defined or operator-defined policies at Block 404 may optionally include, at Block 406, determining the one or more user-defined or operator-defined policies related to a type of the network or a service provider related to the service provider network. Thus, for example, the one or more user-defined or operator-defined policies can correspond to selecting a network of the type or related to the service provider of a network discovered by network discovering component 310, and user-defined policy component 324 and/or operator-defined policy component 326 can obtain and enforce the one or more policies in determining whether to select the network (e.g., based additionally on a type of the current serving network, a time of day, whether credentials are stored for the network, etc.).

In any case, network connecting component 312 can enforce policies defined in the user-defined policy component 324 and/or operator-defined policy component 326 in determining a network to select for access. Thus, method 400 includes, at 408, selecting the network for access based at least in part on the one or more user-defined or operator-defined policies. Thus, when network discovering component 310 discovers network entity 304, network connecting component 312 can determine whether to select the network entity 304 for access (in addition to or instead of network entity 302) based on ensuring that selecting network entity 304 would be in compliance with one or more user-defined or operator-defined policies defined in user-defined policy component 324 or operator-defined policy component 326, as described above, and network connecting component 312 can accordingly select the network for access based at least in part on the one or more user-defined or operator-defined policies. Selecting the network for access at Block 408 can optionally include, at Block 410, selecting the network based at least in part on a type of the network or a type of the serving network. For example, as described, the one or more policies can specify whether selection of the network is permitted based on a type of the network and/or a type of a network currently serving the UE 106. In a specific example, network connecting component 312 may select a network for handover/reselection where the network is of the same or similar type as the serving network (e.g., where network entities 302 and 304 are both associated with an LTE-U-W type of network, automatic selection component 320 may select the network for handover/reselection, where concurrent connections are not allowed at the UE 106 but the discovered network is determined to have more preferable evolved packet core (EPC) connectivity, etc.). In another example, network connecting component 312 may select the network for offloading traffic from the service network (e.g., where one or more policies allow concurrent connections to the serving network or type of serving network and the discovered network or type of network).

Moreover, selecting the network at Block 408 may include requesting authentication from the network and subsequently communicating with the network in handover/reselection or in an offload capacity. Requesting authentication, as described herein, can be based on providing stored credentials to the network, which may be from a universal subscriber mobile identity (USIM) of the UE 106 used to access mobile networks, related to previously stored credentials for a determined service provider of the network, and/or the like. It is to be appreciated that network connecting component 312 may select a network and/or connect to the network as part of handing over from another network (e.g., a handover/reselection from network entity 302 to network entity 304, which may be a handover/reselection between different RATs), as part of offloading traffic from a serving network to another network (e.g., from network entity 302 to network entity 304) to improve throughput at UE 106 and/or conserve resources at network entity 302, etc.

Selecting network entity 304 can be automatic or manual, and thus network connecting component 312 can include an automatic selection component 320 and/or a manual selection component 322. Automatic selection component 320 can evaluate discovered network entities based on the one or more user-defined or operator-defined policies, and can automatically select a network entity (e.g., for handover/reselection, offloading communications, or other mobility/inter-working with a serving cell) where doing so complies with the one or more policies. Manual selection component 322 can allow for manual discovery and selection of network entities. For example, manual selection component 322 can provide a list of discovered network entities on an interface of the UE 106, and can allow for selection of a network entity (e.g., for handover/reselection, offloading communications or other mobility/inter-working with a serving cell). It is to be appreciated that manual selection component 322 can also verify that network entities presented on the interface and/or network entities selected via the interface comply with the one or more user-defined or operator-defined policies.

Method 400 may optionally include, at Block 412, adding the network to a blacklist based at least in part on detecting failure of authentication in selecting the network. Network blacklisting component 314 can add the network to the blacklist, which may be stored by or otherwise associated with UE 106, based at least in part on detecting failure of authentication in selecting the network by network connecting component 312. For example, credential providing component 330 may store a list of credentials for accessing one or more networks, types of networks, networks operated by a specific service provider, etc. This can include credentials stored in a USIM of the UE 106 that may have been configured by a MNO, credentials received from one or more networks, credentials input (e.g., using an interface of the UE 106) for a specific network, network type, or service provider, etc., as described. Network connecting component 312 can utilize credentials for connecting to a network (e.g., as selected by automatic selection component 320 or via manual selection component 322), which can relate to a network provided by network entity 304. If network entity 304 denies a selection request from the UE 106 due to failed authentication (e.g., after one or more attempts), network blacklisting component 314 can add an identifier of the network and/or service provider to the blacklist.

Accordingly, automatic selection component 320 can obtain the blacklist upon determining to select to a network to ensure the network is not in the blacklist (e.g., otherwise automatic selection component 320 may not select the network). Similarly, in an example, manual selection component 322 can obtain the blacklist upon determining to present a list of one or more network to ensure the one or more networks are not in the blacklist (e.g., otherwise manual selection component 322 can refrain from including the network in the list for presenting on an interface for manual network selection). It is to be appreciated that network blacklisting component 314 may add one or more networks, network types, service provider identifiers, etc. to the blacklist for other reasons as well (e.g., where a quality, throughput, etc. is below an average threshold, and/or the like). Moreover, it is to be appreciated that multiple networks may use the same network identifier, due to unmanaged deployment of WWAN hotspots. Thus, method 400 may optionally include, at Block 414, removing the network from the blacklist after a configured period of time. Network blacklisting component 314 can remove the network from the blacklist after the configured period of time. This allows the UE 106 to attempt access possibly to other networks with similar identifiers after the period of time. It is to be appreciated that the period of time may be configured in a configuration of the UE 106, received from a network entity, etc.

FIG. 5 illustrates an example method 500 for providing a list of networks for selection via an interface. Method 500 may include, at Block 402, discovering a network that advertises access to a service provider network via a cellular RAT in an unlicensed frequency band. Network discovering component 310 can discover the network that advertises access to the service provider network via the cellular RAT in the unlicensed frequency band, as described. In an example, discovering the network at Block 402 may include, at Block 502, searching a plurality of networks including both WLANs and networks that communicate using the cellular RAT in the unlicensed frequency band. As described further herein, network discovering component 310 can search the plurality of networks including both WLANs and networks that communicate using the cellular RAT in the unlicensed frequency band. For example, network discovering component 310 can search for signals from one or more network entities related to the plurality of networks (e.g., network entity 304) in the WLAN and/or unlicensed frequency band. In an example, network discovering component 310 may be configured with one or more frequencies and/or related RATs over which to search for network for handover/reselection, offloading, etc., as described. Network discovering component 310 can discover one or more networks in this regard and can report the one or more networks to network connecting component 312 for automatic or manual selection thereof, as described.

Method 500 may also optionally include, at Block 504, providing a list of available networks, via an interface, including at least one WLAN or at least one network that communicates using the cellular RAT in the unlicensed frequency band. Manual selection component 322 may provide the list of available networks, via an interface (e.g., of UE 106), including at least one WLAN or at least one network that communicates using the cellular RAT in the unlicensed frequency band (e.g., an LTE-U-W network). For example, manual selection component 322 may not provide LTE-U-M networks in the list (unless the LTE-U-M networks also advertise LTE-U-W capabilities) as selection of LTE-U-M networks may be automatic since the LTE-U-M network entity can be similar to an LTE network entity. In any case, manual selection component 322 may provide the list of networks, and may include one or more icons or other graphical representations to differentiate LTE-U-W networks from WLAN networks. Moreover, as described, it is to be appreciated that manual selection component 322 may provide the list of networks based on determining that the list of networks comply with one or more user-defined or operator-defined policies, as described.

Method 500 may also optionally include, at Block 506, indicating, via the interface, whether credentials are stored for the at least one network that communicates using the cellular RAT in the unlicensed frequency band. Manual selection component 322 can indicate, via the interface (e.g., of UE 106), whether credentials are stored for the at least one network that communicates using the cellular RAT in the unlicensed frequency band. For example, manual selection component 322 may include an icon or other graphical depiction for a network in the list of networks that indicates that credentials are stored for the network. Thus, a user may select a network for which credentials are already stored if available, for example.

Method 500 may also optionally include, at Block 508, selecting the network for access based at least in part on one or more user-defined or operator-defined policies. Network connecting component 312 may select the network for access based at least in part on the one or more user-defined or operator-defined policies to ensure selection of the network (e.g., for handover/reselection, offloading, etc.) is consistent with the one or more policies, as described.

In one or more examples described above, the one or more user-defined or operator-defined policies may be based on a service provider of the network. Thus, UE 106 can also optionally include a service provider identifying component 328 for determining a service provider that provides the backend support for the network entity 304. For example, the service provider may advertise an identifier in a broadcast or other signal from a related network entity (e.g., network entity 304), and the network connecting component 312 can determine whether to select the network, or the manual selection component 322 can determine whether to present an identifier of the network for manual selection, based at least in part on determining one or more user-defined or operator-defined policies related to the identifier of the service provider. Moreover, in an example, the UE 106 may optionally include credential providing component 330, as described, for providing credentials to the network entity 304 to access the network via network entity 304. In an example, credential providing component 330 may provide the credentials based at least in part on the identified service provider. For example, network entity 304 may correspond to a service provider to which the UE 106 is associated (e.g., by subscription or otherwise), and credential providing component 330 may possess credentials for the service provider. In this example, service provider identifying component 328 can identify a service provider related to an automatically or manually selected service provider, and credential providing component 330 can obtain and provide the credentials to network entity 304. In addition, for example, credential providing component 330 can allow for manual specification and provisioning of credentials for a given network entity/service provider, receiving credentials via an OSU server related to the network entity (e.g., based on interacting with an interface related to the OSU server), etc., which credential providing component 330 can then provide to network connecting component 312 for selecting a network for which credential providing component 330 has stored credentials for authenticated the UE 106 on the network.

In a specific example, in selecting an LTE-U network for connectivity and for mobility between accesses, the UE 106 may perform the selection considering one or more of the following rules.

(1) For mobility (e.g., handover/reselection) and/or interworking (e.g., offloading) between LTE and LTE-U-W, and between LTE and LTE-U-M, network connecting component 312 can perform interworking and mobility at system level (e.g., internet protocol (IP) level mobility) with an LTE-U-W network used as a WLAN access, session continuity through common core network. In such case the network connecting component 312 can use mechanisms defined by 3GPP (e.g. S2a, S2b or Non Seamless WLAN Offload (NSWO)) for mobility between accesses, specifically between an LTE/LTE-U-M network (e.g., or related network entity, such as network entity 302), and an LTE-U-W network (e.g., or a related network entity, such as network entity 304).

(2) For mobility/interworking between LTE and LTE-U-M, tight interworking may be possible where the LTE network entity is in control of the mobility at the eNB level between LTE and LTE-U-M. In this example, network connecting component 312 can perform mobility/selection between an LTE network (e.g., or related network entity, such as network entity 302) and an LTE-U-M network (e.g., or related network entity, such as network entity 304) based on LTE radio mechanisms, including the ability to perform radio link control (RLC) aggregation where both the LTE and the LTE-U-M radios can be used concurrently with IP data being transmitted and received on both radios. When detecting an LTE-U-M network entity, the network connecting component 312 can consider this network entity as another regular LTE network entity (e.g., providing an LTE cell) due to the ability to use the LTE radio mechanisms, and in one example, automatic selection component 320 can automatically select the discovered LTE-U-M network for handover/reselection or offloading from the LTE network.

(3) For mobility/interworking between an LTE/LTE-U-M network (e.g., or related network entity, such as network entity 302) and an LTE-U-W network (e.g., or a related network entity, such as network entity 304), network connecting component 312 can utilize system level interworking mechanisms defined in 3GPP for mobility/interworking between cellular and WLAN. Example automatic and manual discovery/selection for such networks via automatic selection component 320 and manual selection component 322 are described further below. For mobility, for example, network connecting component 312 can use 3GPP mechanisms such as S2a, S2b or NSWO. Moreover, it is to be appreciated that an LTE-U network may be operated both as an operator network providing traditional 3GPP service (e.g., LTE-U-M) and as a WWAN hotspot service (e.g., LTE-U-W) based on connecting to the MNO on the backend to provide the LTE-U-M access. When scanning for available networks, network discovering component 310 detects the LTE-U network and the access stratum (AS) indicates to the upper layers both an available LTE-U-W network and an available LTE-U-M network. Network connecting component 312 can then decide whether to connect to a 3GPP access or the WWAN hotspot functionality on this network based on one or more user-defined or operator-defined policies or other considerations of the networks or the type of network being LTE-U-W or LTE-U-M, etc.

(4) For mobility/interworking between LTE-U-W and WLAN networks, LTE-U-W and WLAN can be seen as two alternative offload technologies such that network connecting component 312 can select one or the other based on user-defined or operator-defined policies, network type, etc., and/or additional considerations, such as measured or reported quality of the access, user preferences, service provider policies, etc. In one example, a connection manager in network connecting component 312 can treat LTE-U-W and WLAN networks as similar for the purposes of selection, providing credentials, etc. Moreover, automatic selection component 320 and/or manual selection component 322 can utilize 3GPP mechanisms, such as WLAN network selection (WLAN NS), for the selection and/or presenting a list of networks, and access network discovery and selection function (ANDSF) support, as defined for WiFi, for LTE-U-W (for selection and traffic steering policies).

Using the above example rules for performing network selection, upon detecting availability of LTE-U networks by network discovering component 310, manual selection component 322 can determine whether the network is an LTE-U-M, LTE-U-W or both and may report to the upper layers the presence of only one MNO network (e.g., if LTE-U-M), or a WWAN hotspot (e.g., if LTE-U-W), or both (if an MNO network and a hotspot). In one example, as described, manual selection component 322 may display the LTE-U-W networks (e.g., along with WLAN networks) but may not display LTE-U-M networks. Upon detecting availability of LTE-U-W networks, the network connecting component 312 can select whether to connect to LTE-U-W and/or which LTE-U-W network to connect to based on various considerations described above and further herein.

In one example, network connecting component 312 can select whether to connect to an LTE-U-W network and/or which LTE-U-W network to connect based on the current technology in use (e.g. LTE, WLAN, LTE-U-M, etc.) (e.g., a technology of network entity 302). This may be configured in the network connecting component 312 and/or may be based on one or more user-defined or operator-defined policies, for example. As described, network connecting component 312 can select whether to connect to an LTE-U-W network and/or which LTE-U-W network to connect based on user-defined or operator-defined policies (e.g. operator policies) in user-defined policy component 324 or operator-defined policy component 326. For example, the operator policies can relate to system level mobility (e.g., S2a, S2b, NSWO) or radio access network (RAN)/eNB-level interworking. Accordingly, for example, network discovering component 310 can discover LTE-U-W networks that support S2a connectivity (e.g., using access network query protocol (ANQP) procedures to retrieve information advertised by the LTE-U-W network or related network entity that indicates PLMNs that interwork with the LTE-U-W network. Network connecting component 312 may prefer networks that support S2a in selecting networks for handover/reselection, offloading, etc. such to select networks that support S2a over those that do not.

Thus, in an example, user-defined policy component 324 and/or operator-defined policy component 326 may include one or more policies related to ANDSF policies, such as inter-system routing policies (ISRP), inter-access point name (Inter-APN) routing policies (TARP), WLAN selection policies (WLANSP), etc., which can indicate how a UE 106 can route traffic over 3GPP access (e.g., LTE) and over LTE-U-W or WLAN. In one example, one or more policies may indicate whether the UE is to prefer unlicensed hotspot selection rules (e.g., selection rules for both WLAN and LTE-U-W or other WWAN hotspots, which may be specified as WLANSPs) provided by the UE's HPLMN or not. Network connecting component 312 can accordingly select one or more networks based on the one or more policies, as described.

If the UE 106 is not capable of simultaneous operations over LTE and LTE-U-W over a given communication resource, for example, when the UE 106 is connected to EPC over WLAN access, an TARP rule and/or user-defined policies/preferences can be used to determine if traffic should be routed inside a specified packet data network (PDN) connection or offloaded to a selected LTE-U-W or WLAN hotspot. Similarly, network connecting component 312 can utilize an inter-system mobility policy (ISMP) to determine if EPC connectivity is preferred over the LTE-U-W or WLAN hotspot access or over a 3GPP access. When EPC connectivity is preferred over the LTE-U-W or WLAN hotspot access (e.g., a highest priority ISMP rule in the ANDSF policies corresponds to a LTE-U-W or WLAN technology/network), WLANSP rules can be used to determine the most preferred LTE-U-W or WLAN hotspot access network.

In addition, network selection can additionally be based on UE capabilities such that if the UE 106 is capable of simultaneous operations over LTE and LTE-U-W, network discovering component 310 can discover and report, and/or network connecting component 312 can select, an LTE-U-W network based on policies (e.g., WLANSP) in the user-defined policy component 324 or operator-defined policy component 326 (and/or based on the user manually selecting an LTE-U-W network in a list provided by manual selection component 322). In this example, network entity 302 may correlate to an LTE network, and network entity 304 may correlate to an LTE-U-W network that is most preferred of other available networks based on the one or more policies. If the UE 106 is connected to a WLAN network (e.g., network entity 304 is a WLAN/WiFi hotspot) and an ISRP prefers an LTE-U-W network, it is possible that the UE 106 may encounter the LTE-U-W network or that a new data flow triggers a rule that prefers an already discovered LTE-U-W network. In either case, network connecting component 312 may connect to the LTE-U-W network even if it means disconnecting from the WLAN network. Other events related to policies may cause the network connecting component 312 to select a different network, type of network, network associated with a certain service provider, etc., such as a chance in location, time-of-day, or other parameters that may be specified for preferring certain networks, types of networks, networks of certain service providers, etc. In any case, it is to be appreciated that traffic steering between LTE and LTE-U-W may be based on ANDSF policies or policies configured in, or otherwise provisioned to, the UE 106.

If the UE 106 is capable of simultaneous operations over LTE and LTE-U-W and if the UE 106 is already connected to WLAN (e.g., network entity 302 is a WLAN network entity), network discovering component 310 can discover, and network connecting component 312 can select, an LTE-U-W network (e.g., related to network entity 304) based on policies (e.g., WLANSP) in the user-defined policy component 324 or operator-defined policy component 326 (and/or based on the user manually selecting an LTE-U-W network in a list provided by manual selection component 322). In this regard, the network connecting component 312 can connect simultaneously to LTE, LTE-U-W and WLAN, where the LTE-U-W and WLAN networks may be the most preferred (and/or a related to a most preferred service provider) of other available LTE-U-W and WLAN networks based on the one or more policies. Traffic steering between LTE and LTE-U-W and WLAN is based on ANDSF policies (e.g., ISRP, IARP, etc.) or policies configured in, or otherwise provisioned to, the UE 106. For example, ISRP for multiple-access PDN connectivity (MAPCON), ISRP for IP flow mobility (IFOM), ISRP for NSWO, etc. can include LTE-U-W networks in the list of prioritized access networks (e.g., along with 3GPP and WLAN networks), as described, for determining PDN connection establishment, IP flow, offloading, etc.

In specific examples, in automatic selection, network connecting component 312 can control cellular and WLAN connectivity, and can select offload from cellular to either WLAN or LTE-U-W or both simultaneously, and handover/reselection between WLAN and LTE-U-W for discovered networks. Mechanisms defined by 3GPP for WLAN network selection (e.g., mechanisms based on ANDSF and the WLAN NS mechanism defined in 3GPP Technical Specification (TS) 23.402/TS 24.302 from Rel. 12 and onward) can be extended to consider LTE-U-W. For example, network discovering component 310, besides discovering WLAN network features using HotSpot 2.0 as defined for WLAN wireless communications, can also discover LTE-U-W features similarly to using HotSpot 2.0, and network connecting component 312 can consider such features when performing network selections. User-defined policies and operator-defined policies in user-defined policy component 324 and operator-defined policy component 326 can mix policies for, and/or consider policies as applying to both, WLAN and LTE-U-W. For example, when a policy rule includes a list of preferred networks, the list can include both identifiers of WLAN networks (e.g., service set identifiers (SSID)) and LTE-U-W networks (e.g., home node B (HNB) names). In another example, when a policy rule includes a list of preferred service providers to be supported by the selected network, the network connecting component 312 can consider both WLAN and LTE-U-W networks that support the preferred service providers for network access (and/or manual selection component 322 can consider both WLAN and LTE-U-W networks that support the preferred service provider for presenting the networks on an interface for manual selection). For example, network discovering component 310, in this regard, may search for WLAN and/or LTE-U-W networks related to the preferred service providers, which may include searching one or more related frequency bands, for signals of one or more RATs, etc., as described.

The operator associated with the UE 106 (e.g., an MNO of a home PLMN for the UE 106) and/or a user associated with the UE 106 can define policies indicating whether LTE-U-W can be used simultaneously and under what conditions they can be used, for example, which may be stored and/or managed by operator-defined policy component 326 and/or user-defined policy component 324. In one example, a given policy can include an indication of “simultaneous LTE-U-W and WLAN.” When the indication is set, if the UE 106 is connected to LTE and is capable of simultaneous transmission over LTE and LTE-U-W, simultaneous connection over LTE-U-W and WLAN, and/or the like, then the network connecting component 312 can connect to both a WLAN and a discovered LTE-U-W network when available and according to the conditions defined in the policy. When the network connecting component 312 connects simultaneously to LTE, LTE-U-W and WLAN, or to LTE-U-W and WLAN, the UE 106 can use ANDSF policies (e.g. inter-system routing policies (ISRP)) or policies configured in the device to determine which data (e.g., internet protocol (IP)) traffic is carried over which access (e.g., to which network entity 302/304).

In manual selection, in these specific examples, LTE-U-W can be treated in the device as a WLAN network and managed within the same connectivity framework as WLAN in order to achieve the same service provisioning model as WLAN hotspots. Thus, for example, in a manual scan for available networks, manual selection component 322 can present a list of available networks via an interface that includes both available WLAN and available LTE-U-W networks. In such list, the HNB Name of an LTE-U-W network can be used like a SSID of a WLAN network to indicate an identity of the LTE-U-W network. As part of this process, manual selection component 322 may not show other LTE-U networks on the interface (e.g. LTE-U-O or LTE-U-M networks since those are not to be selected manually by the user).

In addition, in the same way that in the manual discovery of WLAN network the Service Provider(s) associated to a WLAN hotspot are indicated on an interface of UE 106, manual selection component 322 may indicate a Service Provider(s) or other information associated to a WWAN (e.g., LTE-U-W) hotspot discoverable as in HotSpot 2.0 (icon, name, etc.) via the interface. For example, manual selection component 322 may list the WLAN networks and/or LTE-U-W networks in a list on a display, and each LTE-U-W network may have an icon near an identifier that identifies the LTE-U-W network as LTE-U-W and/or each WLAN may have an icon identifying the network as WLAN. In this mechanism, the manual selection component 322 may present to the user the technology associated to an available HotSpot (e.g., WLAN or LTE-U-W) to facilitate the user selection of to which HotSpot to connect. In addition, if the credential providing component 330 determines (e.g., based on the features of the LTE-U-W Hotspot discovered during the scan/search) that the UE 106 is already provisioned with credentials to access the LTE-U-W hotspot (e.g., the UE 106 has credentials that allow authentication with the hotspot), the credential providing component 330 may present such information to the user via the use of appropriate icons (e.g., for the related network(s) in the list of WLAN/LTE-U-W networks). The credential providing component 330 may discover, during a manual scan by manual selection component 322, whether the UE 106 is provisioned for an LTE-U-W hotspot by comparing the service providers for which it has credentials with the list of service providers supported by the LTE-U-W hotspot, in one example. As described, for example, service provider identifying component 328 can determine one or more service providers associated with the LTE-U-W hotspot, and credential providing component 330 may determine whether a store of credentials includes credentials for the one or more service providers associated with the LTE-U-W hotspot.

In an example, once LTE-U networks are added manually via manual selection component 322, such networks can be used together with the list of WLAN and LTE-U networks that the network discovering component 310 dynamically discovers. It is to be appreciated that the UE 106 or a user thereof need not be aware of whether a selected network is WLAN or LTE-U-W, rather the hotspot can be selected by name or service provider name. This enables a service provider to deploy WLAN and LTE-U-W interchangeably as hotspots. Reuse of HotSpot 2.0 like mechanisms, as described above, can enable efficient and flexible deployment models and connectivity establishment. When an LTE-U network that supports a specific service provider is added to a list of networks for selection (e.g., by manual selection component 322 or otherwise such that credentials are obtained for the network), by using the Service Provider identity (and the ability to discover SP behind an LTE-U-W eNB), credential providing component 330 can store and reuse credentials for the network in other networks (e.g., networks having the same service provider identified by service provider identifying component 328). In one example, credential providing component 330 can store credentials for a network of a service provider, and reuse the credentials in requesting authentication for another network of the service provider where the networks use different RATs (e.g., a LTE-U-W network and a WLAN network having the same or similar/related service provider).

In the above examples, the network identifier space for networks such as LTE-U-W may be unmanaged, e.g., no entity manages the identifiers used by different networks (as can be the case with WLAN as well). This implies that two networks with different service providers can use the same or similar network identifiers. This may result in network connecting component 312 gaining access to a first network using a first network identifier, but not to a second network having the same network identifier (e.g. because the second network does not have roaming agreements with the network providing credentials to the UE 106 or otherwise cannot validate credentials from credential providing component 330). As described, in this example, network blacklisting component 314 can determine a failure in authentication, and may populate a blacklist with additional information regarding the network to prevent subsequent access attempts to the network. Network blacklisting component 314 can add the network information to the blacklist in this regard. When the network is added to the blacklist by network blacklisting component 314, network connecting component 312 can ensure subsequent networks are not in the blacklist before attempting access, and thus access to the blacklisted networks is avoided (e.g., unless the network is manually added via manual selection component 322). The network information added to the blacklist can include a public land mobile network (PLMN) identifier (if present), closed subscriber group (CSG) identifier, HNB Name, supported Service Provider etc. of the network, which can help to distinguish the network from networks with the same identifier to which the UE 106 can connect. In this regard, network connecting component 312 can determine whether a network (or related network entity) discovered by network discovering component 310 is in the blacklist based on filtering the blacklist on not only the identifier of the network or related network entity, but also possibly on the PLMN identifier, CSG identifier, HNB name, etc. before requesting access/authentication. It is to be appreciated that network blacklisting component 314 can blacklist such networks for a predefined period of time (e.g. configured in the UE 106 by service provider, the device manufacturer, etc.), and can remove the network from the blacklist after the period of time, as described.

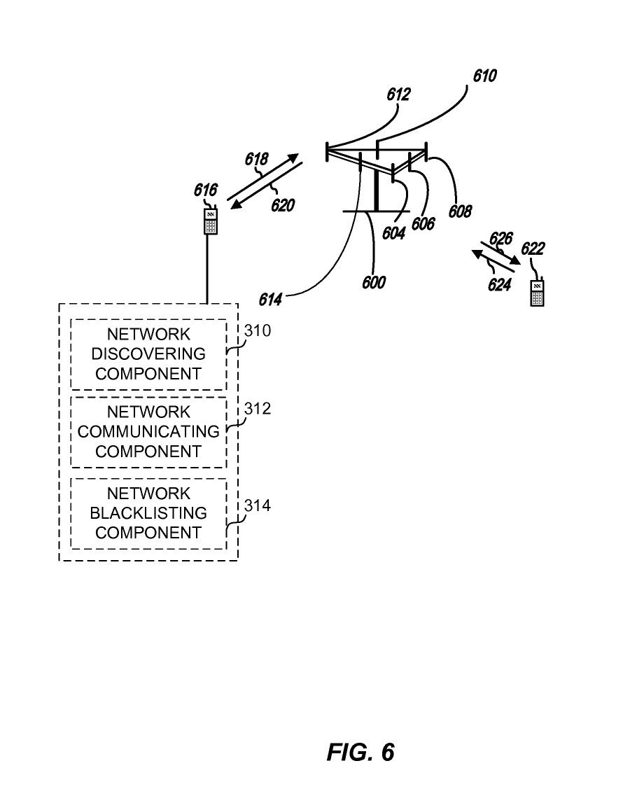

Referring to FIG. 6, a multiple access wireless communication system according to one embodiment is illustrated. An access point 600 (AP) includes multiple antenna groups, one including 604 and 606, another including 608 and 610, and an additional including 612 and 614. In FIG. 6, only two antennas are shown for each antenna group, however, more or fewer antennas can be utilized for each antenna group. Access terminal 616 (AT) is in communication with antennas 612 and 614, where antennas 612 and 614 transmit information to access terminal 616 over forward link 620 and receive information from access terminal 616 over reverse link 618. Access terminal 622 is in communication with antennas 604 and 606, where antennas 604 and 606 transmit information to access terminal 622 over forward link 626 and receive information from access terminal 622 over reverse link 624. In a FDD system, communication links 618, 620, 624 and 626 can use different frequency for communication. For example, forward link 620 can use a different frequency then that used by reverse link 618. AT 616 and/or 622 may be and/or may include a UE 106, as described herein, and thus may include one or more components thereof, such as a network discovering component 310 for discovering one or more networks for which access is advertised (e.g., by a WWAN hotspot, WiFi hotspot, etc.), a network connecting component 312 for communicating with one or more of the networks based at least in part on one or more policies, and/or a network blacklisting component 314 for adding a network for which authentication fails to a blacklist to prevent subsequent attempts for accessing the network for at least a period of time.

Each group of antennas and/or the area in which they are designed to communicate is often referred to as a sector of the access point. In the embodiment, antenna groups each are designed to communicate to access terminals in a sector of the areas covered by access point 600.

In communication over forward links 620 and 626, the transmitting antennas of access point 600 utilize beamforming in order to improve the signal-to-noise ratio of forward links for the different access terminals 616 and 622. Also, an access point using beamforming to transmit to access terminals scattered randomly through its coverage causes less interference to access terminals in neighboring cells than an access point transmitting through a single antenna to all its access terminals.

Moreover, access terminals 616 and 622 can provide UE functionality, described in connection with UE 106 above, to discover network entities and perform related selection procedures. Similarly, in this regard, access point 600 can include a network entity 302/304 to which the UE 106 can communicate and/or select for network access, as described herein.

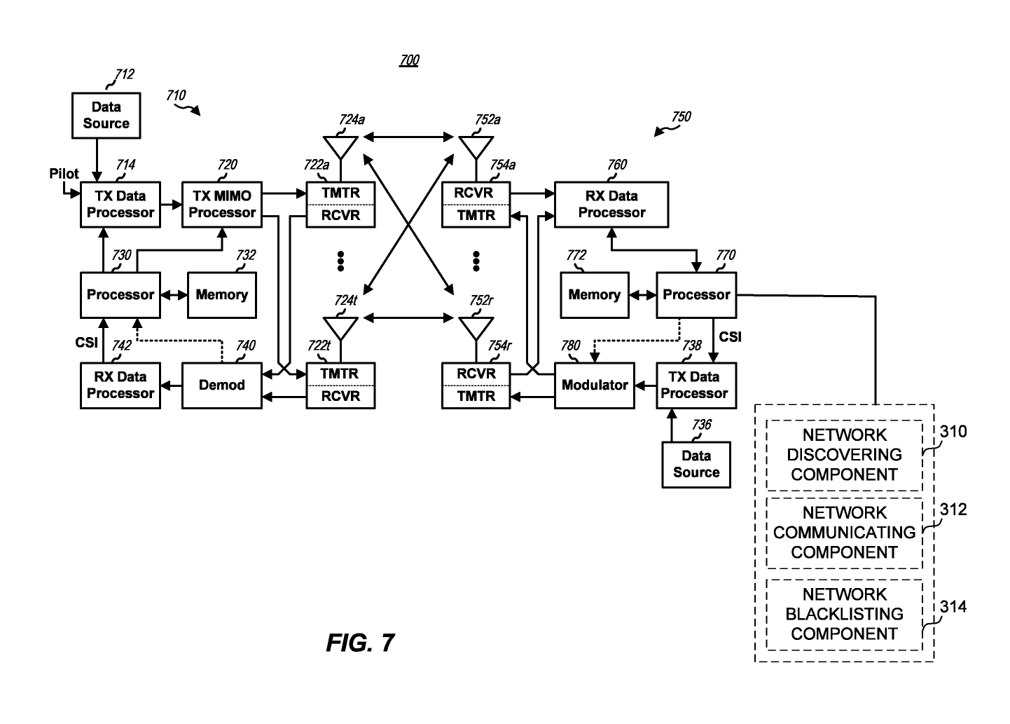

FIG. 7 is a block diagram of an embodiment of a transmitter system 710 (also known as the access point) and a receiver system 750 (also known as access terminal) in a MIMO system 700. In an example, receiver system 750 may be and/or may include a UE 106, as described herein, and thus may include one or more components thereof, such as a network discovering component 310 for discovering one or more networks for which access is advertised (e.g., by a WWAN hotspot, WiFi hotspot, etc.), a network connecting component 312 for communicating with one or more of the networks based at least in part on one or more policies, and/or a network blacklisting component 314 for adding a network for which authentication fails to a blacklist to prevent subsequent attempts for accessing the network for at least a period of time. At the transmitter system 710, traffic data for a number of data streams is provided from a data source 712 to a transmit (TX) data processor 714. In addition, it is to be appreciated that transmitter system 710 and/or receiver system 750 can employ the systems (FIGS. 1-3 and 6) and/or methods (FIGS. 4 and 5) described herein to facilitate wireless communication there between. For example, components or functions of the systems and/or methods described herein can be part of a memory 732 and/or 772 or processors 730 and/or 770 described below, and/or can be executed by processors 730 and/or 770 to perform the disclosed functions.

In an embodiment, each data stream is transmitted over a respective transmit antenna. TX data processor 714 formats, codes, and interleaves the traffic data for each data stream based on a particular coding scheme selected for that data stream to provide coded data.

The coded data for each data stream can be multiplexed with pilot data using OFDM techniques. The pilot data is typically a known data pattern that is processed in a known manner and can be used at the receiver system to estimate the channel response. The multiplexed pilot and coded data for each data stream is then modulated (e.g., symbol mapped) based on a particular modulation scheme (e.g., BPSK, QSPK, M-PSK, or M-QAM) selected for that data stream to provide modulation symbols. The data rate, coding, and modulation for each data stream can be determined by instructions performed by processor 730.

The modulation symbols for all data streams are then provided to a TX MIMO processor 720, which can further process the modulation symbols (e.g., for OFDM). TX MIMO processor 720 then provides N_{T} modulation symbol streams to N_{T} transmitters (TMTR) 722a through 722t. In certain embodiments, TX MIMO processor 720 applies beamforming weights to the symbols of the data streams and to the antenna from which the symbol is being transmitted.

Each transmitter 722 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 722a through 722t are then transmitted from N_{T} antennas 724a through 724t, respectively.

At receiver system 750, the transmitted modulated signals are received by N_{R} antennas 752a through 752r and the received signal from each antenna 752 is provided to a respective receiver (RCVR) 754a through 754r. Each receiver 754 conditions (e.g., filters, amplifies, and downconverts) a respective received signal, digitizes the conditioned signal to provide samples, and further processes the samples to provide a corresponding “received” symbol stream.

An RX data processor 760 then receives and processes the N_{R} received symbol streams from N_{R} receivers 754 based on a particular receiver processing technique to provide N_{T} “detected” symbol streams. The RX data processor 760 then demodulates, deinterleaves, and decodes each detected symbol stream to recover the traffic data for the data stream. The processing by RX data processor 760 is complementary to that performed by TX MIMO processor 720 and TX data processor 714 at transmitter system 710.

A processor 770 periodically determines which pre-coding matrix to use. Processor 770 formulates a reverse link message comprising a matrix index portion and a rank value portion.

The reverse link message can comprise various types of information regarding the communication link and/or the received data stream. The reverse link message is then processed by a TX data processor 738, which also receives traffic data for a number of data streams from a data source 736, modulated by a modulator 780, conditioned by transmitters 754a through 754r, and transmitted back to transmitter system 710.

At transmitter system 710, the modulated signals from receiver system 750 are received by antennas 724, conditioned by receivers 722, demodulated by a demodulator 740, and processed by a RX data processor 742 to extract the reserve link message transmitted by the receiver system 750. Processor 730 then determines which pre-coding matrix to use for determining the beamforming weights then processes the extracted message.

Processors 730 and 770 can direct (e.g., control, coordinate, manage, etc.) operation at transmitter system 710 and receiver system 750, respectively. Respective processors 730 and 770 can be associated with memory 732 and 772 that store program codes and data. For example, processors 730 and 770 can perform functions described herein with respect to UE 106, eNB 108, network entities 302/304, etc., and/or can operate one or more of the corresponding components. Similarly, memory 732 and 772 can store instructions for executing the functionality or components, and/or related data.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal.

In one or more aspects, the functions, methods, or algorithms described may be implemented in hardware, software, firmware, or any combination thereof. If implemented in software, the functions may be stored or transmitted as one or more instructions or code on a computer-readable medium, which may be incorporated into a computer program product. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, substantially any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for detecting wireless network services, comprising:
discovering, at a user equipment (UE), a network that advertises access to a service provider network via a cellular radio access technology (RAT) in an unlicensed frequency band;
determining, by the UE, one or more user-defined or operator-defined policies related to selecting the network; and
selecting the network for access based at least in part on the one or more user-defined or operator-defined policies.

2. The method of claim 1, wherein determining the one or more user-defined or operator defined policies related to the network comprises determining the one or more user-defined or operator-defined policies related to selecting networks having a type of the network or a service provider related to the service provider network.

3. The method of claim 1, wherein selecting the network for access is further based at least in part on at least one of a type of the network or another type of a serving network before selecting the network for access.

4. The method of claim 1, wherein at least one of the one or more user-defined policies or operator-defined policies relates to both a wireless local area network and the network that communicates using the cellular RAT in the unlicensed frequency band.

5. The method of claim 1, wherein discovering the network comprises searching a plurality of networks including both wireless local area networks (WLAN) and networks that communicate using the cellular RAT in the unlicensed frequency band.

6. The method of claim 5, further comprising providing a list of available networks via an interface, wherein the list of available networks includes an identifier of at least one WLAN and another identifier of at least one network that communicates using the cellular RAT in the unlicensed frequency band.

7. The method of claim 6, further comprising indicating via the interface whether credentials are stored for the at least one network that communicates using the cellular RAT in the unlicensed frequency band.

8. The method of claim 5, wherein searching the plurality of networks is based at least in part on the one or more user-defined policies or operator-defined policies.

9. The method of claim 5, wherein selecting the network comprises selecting the network for concurrently communicating using the network and a WLAN based at least in part on the one or more user-defined policies or operator-defined policies.

10. The method of claim 5, wherein the one or more user-defined or operator-defined policies indicate whether simultaneous connection is allowed to the WLANs and the networks that communicate using the cellular RAT.

11. The method of claim 1, further comprising:
determining that a second network related to the service provider network advertises access to a mobile network operator (MNO) network via the cellular RAT in the unlicensed frequency band; and
reporting the network and the second network to one or more upper layers, wherein selecting the network includes selecting the network or the second network.

12. The method of claim 1, further comprising adding a network identifier of the network to a blacklist based at least in part on detecting a failure of authentication in selecting the network.

13. The method of claim 12, wherein adding the network identifier to the blacklist comprises adding a public land mobile network, closed subscriber group, service provider, or home node B identifier to the blacklist to facilitate distinguishing the network from other networks having the network identifier.

14. The method of claim 12, further comprising removing the network from the blacklist after a configured period of time.

15. The method of claim 1, wherein selecting the network comprises selecting the network for handover, reselection, or offloading.

16. The method of claim 1, further comprising providing credentials to the network to authenticate the UE on the network, wherein the credentials relate to a selection of another network related to a service provider of the service provider network.

17. An apparatus for detecting wireless network services, comprising:
a network discovering component configured to discover a network that advertises access to a service provider network via a cellular radio access technology (RAT) in an unlicensed frequency band;
a user-defined policy component or an operator-defined policy component configured to determine one or more user-defined or operator-defined policies related to selecting the network; and
a network connecting component configured to select the network for access based at least in part on the one or more user-defined or operator-defined policies.

18. The apparatus of claim 17, wherein the user-defined policy component or the operator-defined policy component is configured to determine the one or more user-defined or operator defined policies related to selecting networks having a type of the network or a service provider related to the service provider network.

19. The apparatus of claim 17, wherein the network connecting component is configured to select the network for access further based at least in part on at least one of a type of the network or another type of a serving network before selecting the network for access.

20. The apparatus of claim 17, wherein at least one of the one or more user-defined policies or operator-defined policies relates to both a wireless local area network and the network that communicates using the cellular RAT in the unlicensed frequency band.

21. The apparatus of claim 17, wherein the network discovering component is configured to discover the network based at least in part on searching a plurality of networks including both wireless local area networks (WLAN) and networks that communicate using the cellular RAT in the unlicensed frequency band.

22. The apparatus of claim 21, further comprising a manual selection component configured to provide a list of available networks via an interface, wherein the list of available networks includes an identifier of at least one WLAN and another identifier of at least one network that communicates using the cellular RAT in the unlicensed frequency band.

23. The apparatus of claim 21, wherein the network discovering component is configured to search the plurality of networks based at least in part on the one or more user-defined policies or operator-defined policies.

24. The apparatus of claim 21, wherein the network connecting component is configured to select the network for concurrently communicating using the network and a WLAN based at least in part on the one or more user-defined policies or operator-defined policies.

25. The apparatus of claim 21, further comprising a network blacklisting component configured to add a network identifier of the network to a blacklist based at least in part on detecting a failure of authentication in selecting the network, wherein adding the network identifier to the blacklist comprises adding a public land mobile network, closed subscriber group, service provider, or home node B identifier to the blacklist to facilitate distinguishing the network from other networks having the network identifier.

26. An apparatus for detecting wireless network services, comprising:
means for discovering a network that advertises access to a service provider network via a cellular radio access technology (RAT) in an unlicensed frequency band;
means for determining one or more user-defined or operator-defined policies related to selecting the network; and
means for selecting the network for access based at least in part on the one or more user-defined or operator-defined policies.

27. The apparatus of claim 26, wherein the means for determining determines the one or more user-defined or operator defined policies related to selecting networks having a type of the network or a service provider related to the service provider network.

28. The apparatus of claim 26, further comprising means for adding a network identifier of the network to a blacklist based at least in part on detecting a failure of authentication in selecting the network, wherein adding the network identifier to the blacklist comprises adding a public land mobile network, closed subscriber group, service provider, or home node B identifier to the blacklist to facilitate distinguishing the network from other networks having the network identifier.

29. A computer-readable storage medium comprising computer-executable code for detecting wireless network services, the code comprising:
code for discovering a network that advertises access to a service provider network via a cellular radio access technology (RAT) in an unlicensed frequency band;
code for determining one or more user-defined or operator-defined policies related to selecting the network; and
code for selecting the network for access based at least in part on the one or more user-defined or operator-defined policies.

30. The computer-readable storage medium of claim 29, further comprising code for adding a network identifier of the network to a blacklist based at least in part on detecting a failure of authentication in selecting the network, wherein adding the network identifier to the blacklist comprises adding a public land mobile network, closed subscriber group, service provider, or home node B identifier to the blacklist to facilitate distinguishing the network from other networks having the network identifier.
